(19) United States
(12) Patent Application Publication
(10) Pub. No.: US 2020/0124335 A1
(43) Pub. Date: Apr. 23, 2020

(54) ICE DISTRIBUTION SYSTEM

(71) Applicants: Auburn University, Auburn, AL (US); precICE, LLC, Mobile, AL (US)

(72) Inventors: Samford T. Myers, Mobile, AL (US); Roy F. Bennett, III, Mobile, AL (US); Benjamin Lembke, Herrick, SD (US); Connor Brown, Vestavia Hills, AL (US); Amr Hisham Abdul-Gaffar, Staten Islan, NY (US); Hunter Shelley, Decatur, AL (US); Jackson Walraven, Decatur, AL (US); Benjamin Waddell, Mobile, AL (US); Robert Simms, Winter Park, FL (US); David Dyer, Auburn, AL (US)

(73) Assignees: Auburn University, Auburn, AL (US); precICE, LLC, Mobile, AL (US)

(21) Appl. No.: 16/660,581

(22) Filed: Oct. 22, 2019

Related U.S. Application Data
(60) Provisional application No. 62/748,957, filed on Oct. 22, 2018.

(51) Int. Cl. F25C 5/20; G06Q 20/20

(52) U.S. Cl. CPC F25C 5/24; F25C 2700/00; F25C 2600/04; G06Q 20/20

(57) ABSTRACT

A system and method for managing the distribution of ice is provided. Generally, the system and method of the present disclosure are designed to easily and conveniently produce and distribute ice to users who pay a fee. The system generally comprises an ice maker, a processor operably connected to at least one of a weight measuring device and a motor, a distributor operably connected to the motor, a power supply, a nozzle, and a non-transitory computer-readable medium coupled to the processor and having instructions stored thereon. In another preferred embodiment, a Point-of-Sale interface may be operably connected to the processor. A user may operate the system by compressing the trigger mechanism of the nozzle and pointing the nozzle at the container in which the user desires to fill with ice. The user may decompress the trigger when the desired amount of ice has been distributed.

### CROSS REFERENCES

This application claims the benefit of U.S. Provisional Application No. 62/748,957, filed on Oct. 22, 2018, which application is incorporated herein by reference.

### FIELD OF THE DISCLOSURE

The subject matter of the present disclosure refers generally to a system and method for making and distributing ice.

### BACKGROUND

Ice was originally distributed to customers as giant blocks that were transported via a wagon. As technology progressed, the first ice machines were created. These ice machines allowed for ice to be packaged and sold at retail locations. Early on, ice was typically packaged in paper bags, but this created issues when melted ice caused the paper bags to lose supportive structure. Technology continued to advance and volumetric packing machines were used to package ice in plastic bags. This made for easier storage and delivery of ice to retail locations and gave customers easy and inexpensive access to packaged ice. Currently, selling bagged ice by specific weight allocations is the primary means in which ice is distributed and consumed.

When consumers purchase bags of ice it can be difficult to predict how much ice a container may need once filled with the items to be cooled. This difficulty often leads to a consumer purchasing too much or too little ice. Additionally, consumers often find it is difficult to lift a container filled with ice into a truck bed or boat. Attempts have been made to provide ice distribution machines which do not require the use of a plastic bag. However, these machines require a user to purchase ice based on preset weight offerings. Additionally, these machines require a user to provide his own ice container, which becomes significantly heavier and more difficult to load into a vehicle or boat once filled with ice.

Accordingly, there is a need in the art for an apparatus, device, system and method for distributing ice which allows a user to purchase an exact amount of ice, not necessarily based on preset weight offerings. Additionally, there is a need in the art for an apparatus, device, system and method for distributing ice which allows a user to fill containers away from the apparatus or distribution system.

### SUMMARY

A system and method for managing the distribution of ice is provided. Generally, the system and method of the present disclosure are designed to easily and conveniently produce and distribute ice to users who pay a fee. The system generally comprises an ice maker, a processor operably connected to at least one of a weight measuring device and a motor, a distributor operably connected to the motor, a power supply, a nozzle, and a non-transitory computer-readable medium coupled to the processor and having instructions stored thereon. In another preferred embodiment, a Point-of-Sale interface (PoS) may be operably connected to the processor. The distributor holds and agitates ice as well as distributes ice to users. In a preferred embodiment, the distributor comprises a housing, a container, a drive rod, and an agitator. The housing is a hollow enclosure having an open end that allows ice to be placed inside the distributor. In a preferred embodiment, the housing is defined by a cylindrical base integrally attached to a continuous cylindrical wall extending vertically from the cylindrical base to the open end. The container holds the ice to be distributed to a user. The housing and container are preferably shaped such that the container may securely fit within the housing. A distribution hole of the housing allows ice to escape the distributor. An exit hole located about the base end of the continuous sidewall allows ice to escape the container. An exit pipe may be attached to the exterior surface of the continuous sidewall about the exit hole in a way such that ice may exit the container via the exit pipe.

The agitator makes forcible contact with ice in the container in a way such that it prevents ice from settling. In embodiments of a container comprising a raised central portion, the agitator pushes ice through the channel created by the raised central portion and propels ice through the exit hole. The agitator preferably comprises a plurality of breaker bars arranged in a way such that rotating the drive rod about a central axis causes the plurality of breaker bars to make forcible contact with the ice within the container. At least one channel blade may be attached to the plurality of breaker bars, wherein the channel blade may be configured to push ice within the container through the exit hole. In embodiments of a container having a channel, the channel blade may be configured to fit within the channel and forcibly engage ice within the channel as the agitator is rotated by the drive rod. The plurality of breaker bars may further comprise a plurality of agitator bars vertically attached and extending upwards towards the top end of container. The plurality of agitator bars may prevent a layer of ice from settling above the breaker bars by extending through any potential ice layers and breaking up those ice layers as the agitator is rotated by the drive rod.

The motor drives the drive rod of the distributor and causes the agitator to rotate about its central axis and distribute ice. The motor is mechanically connected to the agitator via the drive rod. Operation of the motor causes the drive rod to rotate about a central axis, which forces the agitator to rotate within the container. Rotation of the agitator may cause the breaker bars and agitator bars to forcibly engage ice within the system, thus breaking up any ice layers that may have lodged within the distributor. A user may activate the motor by engaging the trigger mechanism of the nozzle so that the trigger mechanism is in an “on” position. The nozzle is a hollow tube that the user may use to direct the flow of ice as needed. The nozzle comprises a distribution tube, a handle, a trigger mechanism, and a circuit operably connected to the motor. The distribution tube is a hollow tube through which ice may flow from the distributor to the user's desired location. The handle is a grip that allows a user to control the distribution tube. The handle may attach to the distribution tube and allows a user to control the distribution tube in a way such that the user may adjust the direction in which ice is ejected from the system. The trigger mechanism allows the user to control the rate of flow of ice from the system. The trigger mechanism is preferably located on the handle in a way such that a user may simultaneously control the distribution tube and the rate of flow of ice. The trigger mechanism preferably comprises a trigger and a spring. In e preferred embodiment, the trigger is moveably attached to the handle in a way such that it may pivot about the handle. The spring is placed between the trigger and the handle in a way such that the trigger is held at a position away from the handle, wherein application of a force on the trigger by the user in a direction towards the handle compresses the spring. The circuit is preferably placed on the handle and the trigger mechanism. Compressing the trigger closes the circuit, which in turn signals to the motor to rotate the drive rod.

In a preferred embodiment, a weight measuring device connected to the distributor may measure the weight of ice before and after a user operates the system. In yet another embodiment this weight measurement happens simultaneously with the distribution of ice, thus showing a user in real-time the amount of ice distributed. The weight measuring device may be attached to the underside of the container and is operably connected to the processor via a wired or wireless connection. The weight of the distributor may be teared such that only the weight of ice within the distributor is measured by the weight measuring device. As ice is placed into the container by the ice maker or removed from the container by the agitator, the weight measuring device may track any changes in weight and transmit the data to the processor. The processor may use this data to determine the weight of the ice distributed by the system while being operated by the user. The ice maker produces the ice the system distributes to a user. The ice maker is operably connected to the processor in a way such that the system may instruct the ice maker when to add ice to the distributor. The ice maker may store ice within a holding bin where the ice may stay until such time that the system sends a computer readable signal that causes the ice maker to transfer ice to the container from the bin. The ice produced by the ice maker may be of many different shapes and sizes. Shapes of ice distributed by the system may include, but are not limited to, cube, half-cube, flake, nugget, crescent, and top hat, or any combination thereof.

A user may purchase ice using a PoS. A computing device having a user interface may be operably connected to the PoS in a way such that a user may use the PoS to make purchases. The computing device may be operably connected to the PoS via Bluetooth, Wi-Fi, fiber optic cable, or other such data transport technologies, but is not limited to these methods of communication. The various methods of the system may use the PoS to confirm payment before distributing ice to a user.

The foregoing summary has outlined certain features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become better understood with regard to the following description, appended claims, and accompanying drawings where:

FIG. 1 is a diagram of a system in which techniques described herein may be implemented.

FIG. 2 is a diagram of a nozzle in which techniques described herein may be implemented.

FIG. 3 is an expanded view of the distributor in which techniques described herein may be implemented.

FIG. 4 is an illustrative screen shot of a computer application consistent with the principles of the present disclosure.

FIG. 5 is a diagram illustrating the manner in which individual access to system settings may be granted or limited based on user or administrator roles.

FIG. 6 is a flow chart illustrating certain method steps of a method embodying features consistent with the principles of the present disclosure.

FIG. 7 is a flow chart illustrating certain method steps of a method embodying features consistent with the principles of the present disclosure.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

As will be evident from the disclosure provided below, the present invention satisfies the need for a system and method capable of making and distributing an amount of ice to a user based on the user's exact needs, and thereby improving upon known systems currently employed within the art.

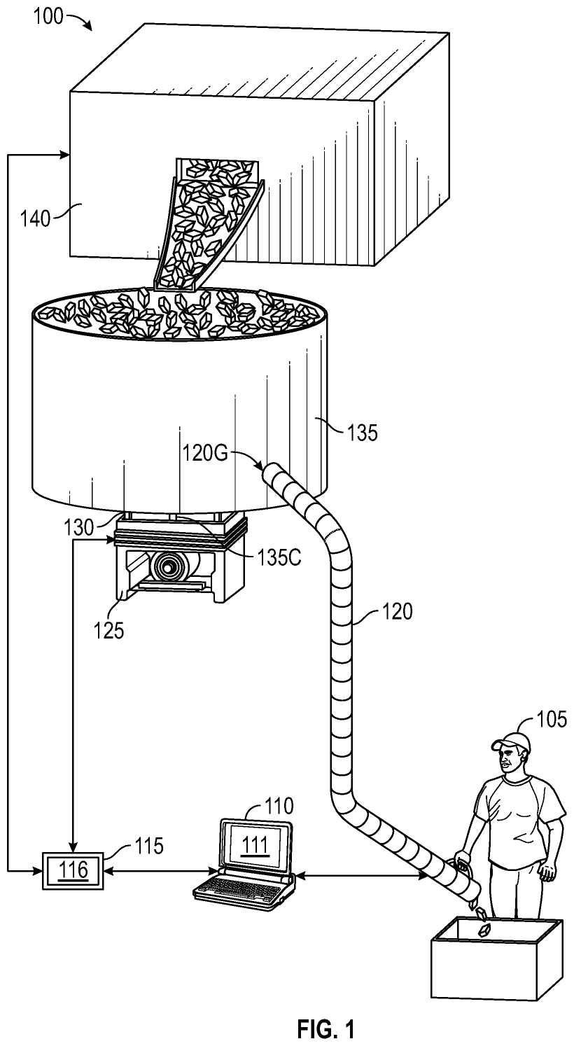

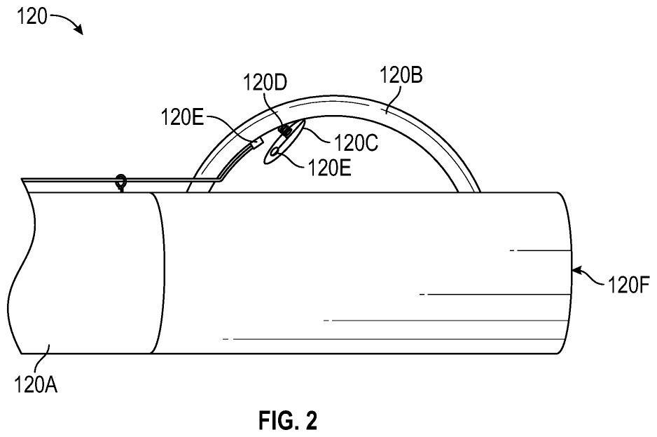

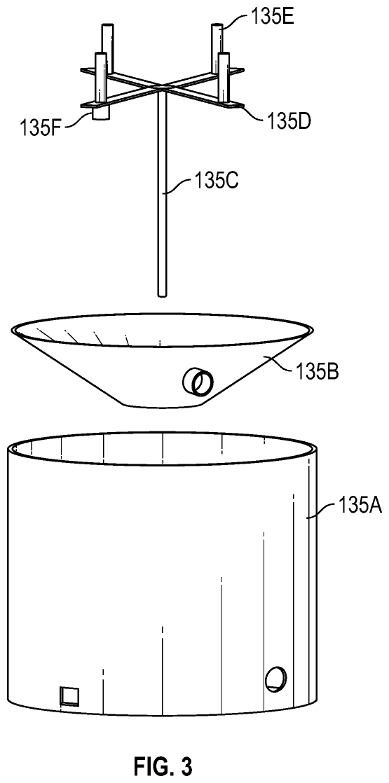

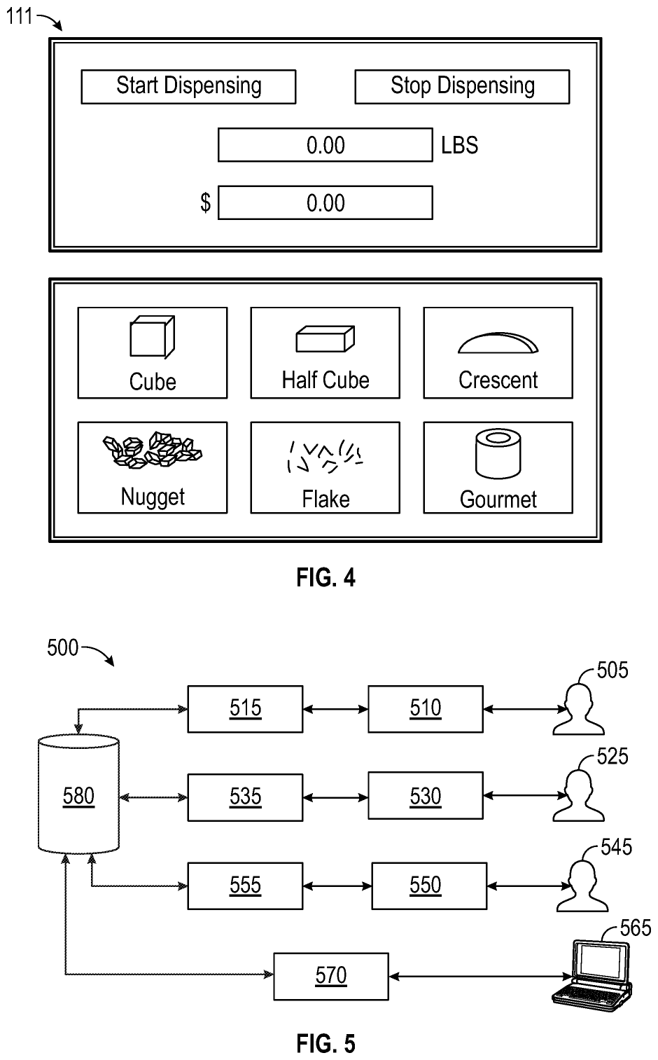

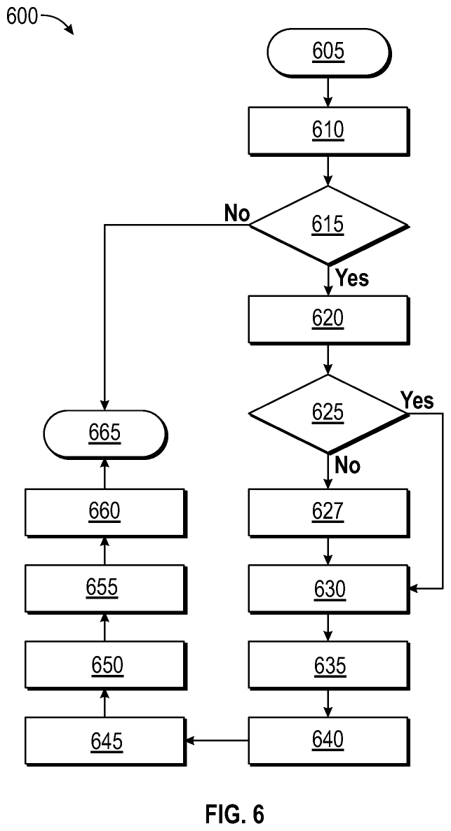

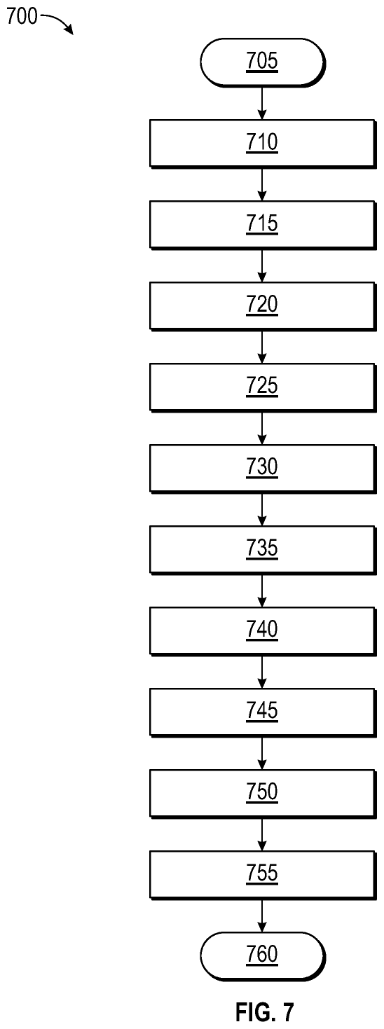

FIGS. 1-7 illustrate embodiments of a system 100 and method for making and distributing ice. FIG. 1 shows an embodiment of the disclosed system 100. The system 100 generally comprises an ice maker 140, a processor 115 operably connected to at least one of a weight measuring device 130 and a motor 125, a distributor 135 operably connected to the motor 125, a power supply, a nozzle 120, and a non-transitory computer-readable medium 116 coupled to the processor 115 and having instructions stored thereon. In another preferred embodiment, a Point-of-Sale interface (PoS) may be operably connected to the processor 115. In yet another preferred embodiment, a display may be operably connected to the processor to allow for display of a user interface. It is understood that the various method steps associated with the methods of the present disclosure may be carried out as operations by the system 100 shown in FIG. 1. FIGS. 6 and 7 show various methods that may be carried out by the system 100. FIG. 5 illustrates permission levels 500 that may be utilized by the present system 100 for controlling access to the various system controls of the user interface 111. FIG. 4 illustrates an example screenshot of a user interface 111 that may be presented via the display. FIG. 3 illustrates a preferred embodiment of a distributor 135 and its various components. FIG. 2 illustrates a preferred embodiment of a nozzle 120.

The distributor 135 holds and agitates ice as well as distributes ice to users 105. In a preferred embodiment, as illustrated in FIG. 3, the distributor 135 comprises a housing 135A, a container 135B, a drive rod 135C, and an agitator. The housing 135A is a hollow enclosure having an open end that allows ice to be placed inside the distributor 135. In a preferred embodiment, the housing 135A is defined by a cylindrical base integrally attached to a continuous cylindrical wall extending vertically from the cylindrical base to the open end. The point at which the cylindrical base and cylindrical wall come together define a base end. The housing 135A and container 135B are preferably shaped such that the container 135B may securely fit within the housing 135A. A distribution hole of the housing 135A allows ice to escape the distributor 135, wherein the ice is pushed through the distribution hole by the agitator. In a preferred embodiment, the housing 135A is thermally insulated in a way to minimize heat transfer between the contents inside the distributor 135 and the walls of the housing 135A. In another preferred embodiment, the housing 135A is constructed of aluminum, but it should be understood by one with skill in the art that any material suitable for creating a housing 135A optimized for ice distribution may be used without departing from the inventive subject matter as described herein.

The container 135B holds the ice to be distributed to a user 105. In a preferred embodiment, as illustrated in FIG. 3, the container 135B is defined by a base integrally attached to a continuous sidewall, creating a bottom end. The continuous sidewall extends upwards towards a top end that is open, which allows ice to be transferred into the container 135B. In a preferred embodiment, the continuous sidewall is tapered in a way such that the container 135B is narrower at the bottom end than the top end. An exit hole located about the base end of the continuous sidewall allows ice to escape the container 135B. In a preferred embodiment, an exit pipe may be attached to the exterior surface of the continuous sidewall about the exit hole in a way such that ice may exit the container 135B via the exit pipe. In one preferred embodiment, the exit pipe may be positioned and sized in a way such that the exit pipe extends through the distribution hole of the housing 135A when the container 135B is placed within the housing 135A. In another preferred embodiment, when the container 135B is placed inside the housing 135A, the top end of the container 135B makes contact with the walls of the housing 135A, and the base of the container 135B interlocks with the cylindrical base of the housing 135A, thus securing the container 135B within the housing 135A. In yet another preferred embodiment, the base of the container 135B may have a raised central portion surrounded by a channel defined by the base, raised central portion, and the continuous sidewall. A drive rod hole centrally located on the base of the container allows a drive rod 135C of the agitator to extend into the container 135B through the base.

The agitator is the part of the distributor 135 that makes forcible contact with ice within the distributor 135 in a way such that it prevents ice from settling. Additionally, the agitator forcibly engages ice within the distributor and propels ice through the exit hole. In a preferred embodiment, as illustrated in FIG. 3, the agitator comprises a plurality of breaker bars 135D arranged in way such that rotating the drive rod 135C about a central axis causes the plurality of breaker bars 135D to make forcible contact with the ice within the container 135B. In a preferred embodiment, the agitator comprises four breaker bars 135D perpendicularly attached to the drive rod 135C at ninety-degree angles and in plane with one another. In another preferred embodiment, the breaker bars 135D are perpendicularly attached to the drive rod 135C at ninety-degree angles and out of plane with one another. At least one channel blade 135F may be attached to the plurality of breaker bars 135D. The channel blades 135F may be configured to forcibly engage ice within the container 135B and propel ice through the exit hole. In the preferred embodiment of a container 135B having a channel, as illustrated in FIG. 3, the channel blade 135F is configured to fit within the channel and forcibly engage ice within the channel, thus propelling ice through the exit hole of the container 135B.

In another preferred embodiment, the plurality of breaker bars 135D may further comprise a plurality of agitator bars 135E vertically attached and extending upwards towards the top end of container 135B. Preferably, the plurality of agitator bars 135E extends up to, but not beyond, the open end of the housing 135A. Because ice melts and refreezes as temperatures fluctuate between the freezing point and melting point of water within the distributor 135, ice may settle in layers within the distributor 135. This is particularly an issue for systems 100 that are not operated for extended periods of time. In situations where a layer of ice settles above the plurality of breaker bars 135D, it is possible that the ice may become lodged within the distributor 135 in a way that makes it difficult for a user 105 to obtain ice from the system 100. The plurality of agitator bars 135E may prevent a layer of ice from settling above the breaker bars 135D by extending through any potential layers and breaking up those layers as the agitator is rotated by the drive rod 135C. The agitator bars 135E are preferably arranged about the breaker bars 135D in a way such that rotating the drive rod 135C about a central axis causes the breaker bars 135D and agitator bars 135E to engage multiple layers of ice, thus preventing ice from getting lodged within the distributor 135. In one preferred embodiment, the breaker bars 135D and agitator bars 135E are L-shaped, which may increase the surface area of the agitator that comes in contact with ice within the distributor 135.

As illustrated in FIG. 1, the system 100 further comprises a motor 125 that is mechanically connected to the agitator via the drive rod 135C. In a preferred embodiment, operation of the motor 125 causes the drive rod 135C to rotate about a central axis, which forces the agitator to rotate within the container 135B. Rotation of the agitator may cause the breaker bars 135D and agitator bars 135E to forcibly engage ice within the system 100, thus breaking up any ice layers that may have lodged within the distributor 135. As illustrated in FIG. 1, the motor 125 may be attached to the outer surface of the distributor 135. In a preferred embodiment, the motor may be encased within the housing 135A of the distributor 135. In a preferred embodiment, the motor 125 is an electric motor having an amount of torque necessary to rotate the drive rod 135C and engage the ice within the system 100. However, it is understood that any type of motor 125 suitable for rotating a drive rod 135C about a central axis may be used without departing from the inventive subject matter as described herein. The user 105 may activate the motor 125 by engaging the trigger mechanism of the nozzle 120 so that the trigger mechanism is in an “on” position. Ice forced out the exit hole by a user 105 engaging the trigger mechanism may move into the distribution tube 120A of the nozzle 120, which a user 105 may manipulate using the handle 120B in order to change the direction in which ice is expelled from the system 100.

The nozzle 120 is a hollow tube through which ice travels before exiting the system 100. In a preferred embodiment, the nozzle 120 comprises a distribution tube 120A having a distributor end 120G and a nozzle end 120F, a handle 120B, a trigger mechanism, and a circuit 120E operably connected to the motor 125. The distribution tube 120A is defined by a cylindrical wall having an inner surface and an outer surface, wherein the cylindrical wall creates a passage defined by the inner surface through which ice may flow from the distributor end 120G to the nozzle end 120F. In a preferred embodiment, the distribution tube 120A is flexible to allow a user 105 to more easily control the direction in which ice is ejected from the nozzle end 120F to the ice delivery location. In another preferred embodiment, as illustrated in FIG. 1, the cylindrical wall of the distribution tube 120A has an accordion like configuration, wherein the cylindrical wall is defined by a series of folds. These folds allow a user 105 to extend the distribution tube 120A or retract the distribution tube 120A to a desired length. In one preferred embodiment, the nozzle 120 may further comprise a counter weight system comprising a weight connected to a cable, wherein the cable may be attached to the distribution tube 120A in a way such that the counter weight system applies a force to the distribution tube 120A in a direction that causes the distribution tube 120A to retract. For instance, a user 105 who has extended a nozzle 120 comprising a counter weight system may release the nozzle 120 so that the counter weight system 100 may exert a force on the nozzle 120 that may cause the distribution tube 120A to retract. In one preferred embodiment, as illustrated in FIG. 1, the distributor end 120G of the distribution tube 120A may attach to the distributor 135 on the outer wall of the housing 135A about the distribution hole. In another preferred embodiment, the distributor end 120G of the distribution tube 120A may attach to the distributor 135 about the exit pipe of the container 135B. As ice is propelled out of the distributor 135 by the agitator, it may enter the distribution tube 120A at the distributor end 120G and exit via the nozzle end 120F to the ice delivery location.

The handle 120B preferably attaches to the distribution tube 120A at the nozzle end 120F, which may allow a user 105 to control the distribution tube 120A in a way such that the user 105 may adjust the direction in which ice is ejected from the system 100 to the ice delivery location. The handle 120B may comprise any grip that would allow a user 105 to control the direction in which the nozzle end 120F of the distribution tube 120A is pointed. The trigger mechanism allows the user 105 to control the rate of flow of ice from the system 100. In a preferred embodiment, the trigger mechanism is located on the handle 120B in a way such that a user 105 may simultaneously control the distribution tube 120A and the rate of flow of ice. The trigger mechanism preferably comprises a trigger 120C, and a spring 120D. The trigger 120C may be moveably attached to the handle 120B in a way such that it may pivot about the handle 120B. The spring 120D is placed between the trigger 120C and the handle 120B in a way such that the trigger 120C is held at a position away from the handle 120B, wherein application of a force on the trigger 120C by the user 105 in a direction towards the handle 120B compresses the spring 120D. In a preferred embodiment, compressing the trigger 120C closes the circuit 120E of the nozzle 120, which in turn signals to the motor 125 to rotate the drive rod 135C.

The circuit 120E is preferably placed on the handle 120B and the trigger mechanism. In a preferred embodiment, the circuit 120E is an open circuit such that compressing the spring 120D via the trigger 120C may cause two open ends of the circuit 120E to contact one another and create a closed circuit. The closing of the circuit 120E may cause the motor 125 to activate in a way that causes the drive rod 135C to rotate about a central axis, which in turn causes the agitator to make forcible contact with ice within the distributor 135. For instance, a user 105 may compress the trigger mechanism of the nozzle 120 to close the circuit 120E and activate the motor 125 so that ice is expelled from the system 100. In another embodiment, the circuit 120E may be a variable circuit, which may allow a user 105 to adjust the speed in which the motor 125 rotates the drive rod 135C depending on the amount of force placed on the spring 120D via the trigger mechanism. For instance, a user 105 may apply a force that slightly compresses the trigger mechanism of the nozzle 120, which may send an ignition signal to the motor 125 to rotate the drive rod 135C about the central axis at a low revolutions per minute. The user 105 may compress the trigger mechanism further to cause the motor 120 to rotate the drive rod 135C at a faster rate. In one preferred embodiment, the processor 115 may control whether the circuit 120E is active or inactive. For instance, the processor 115 may activate a switch that allows the ignition signal to pass to the motor 120 from the circuit 120E when a user 105 has paid via the PoS. In another preferred embodiment, the circuit 120E may send a computer readable signal to the processor 115, which may then be relayed to the motor 120. For instance, a user 105 may close the circuit 120E, causing a computer readable signal to be sent to the processor 115. The processor 115 may then determine whether an ignition signal should be relayed to the motor 120 based on whether the user 105 has paid via the PoS.

A weight measuring device 130 operably connected to the processor 115 may be configured to determine the weight of ice within the system 100. In a preferred embodiment, the weight measuring device 130 is connected to the distributor 135 and may measure the weight of ice before and after a user 105 operates the system 100. In a preferred embodiment the weight measuring device 130 shows to the user 105 in real-time the weight of ice which the user 105 has distributed. Preferably, the weight measuring device 130 is attached to the underside of the container 135B and operably connected to the processor 115. The weight of the container 135B may be tared such that only the weight of ice within the distributor 135 is measured by the weight measuring device 130. As ice is placed into the container 135B by the ice maker or removed from the container 135B by the agitator, the weight measuring device 130 may track any changes in weight and transmit the data to the processor 115. The processor 115 may use this data to determine the weight of the ice distributed by the system 100 while being operated by the user 105. In another preferred embodiment, the weight measuring device 130 may be attached to cylindrical base of the housing 135A. In yet another preferred embodiment, the system 100 may estimate the amount of ice distributed by the system 100 through use of a timing device. For instance, a computing device 110 having a timer may be used to measure the amount of time the system 100 has been in operation and estimate the amount of ice distributed during that time period. In yet another embodiment, the ice drop rate of the system 100 may be used in conjunction with the amount of time the system 100 was in operation, which may allow the system 100 to more accurately calculate the amount of ice distributed. For instance, by multiplying the time in which the system 100 was in operation by the ice drop rate, the system 100 could calculate the amount of ice distributed while operated by the user 105. For example, a system 100 operated by a user 105 for thirty seconds and configured to have a drop rate of thirty pounds per minute would have distributed about fifteen pounds of ice.

The ice maker 140 produces the ice the system 100 distributes to a user 105. In a preferred embodiment, the ice maker 140 receives liquid water from a water supply and cools it in a mold to a temperature that causes the water to crystalize into ice. Once crystalized in the mold, the ice maker 140 may eject the newly formed ice into a holding bin where the ice may sit until such time that the system 100 sends a computer readable signal that causes the ice maker 140 to transfer ice to the distributor 135 from the bin. The ice maker 140 preferably sits above the distributor 135 and transfers ice from the bin to the distributor 135 as needed. In a preferred embodiment, the ice maker 140 is operably connected to the processor 115 in a way such that the system 100 may instruct the ice maker 140 when to transfer ice from the ice maker 140 to the distributor 135. In one preferred embodiment, as ice is pushed out the exit hole of the container 135B by the breaker bars 135D, the weight measuring device 130 may calculate the amount ice remaining in the container 135B. If the weight of ice within the container 135B drops below a certain specified weight, the processor 115 may transmit a computer readable signal to the ice maker 140, which may cause the ice maker 140 to transfer ice from the bin to the distributor 135. Once the weight of ice within the container 135B has increased to a certain specified level due to the transfer of ice from the ice maker 140 to the container 135B, the processor 115 may send a computer readable signal to the ice maker 140, which may instruct the ice maker 140 to stop transferring ice from the bin to the distributor 135. For example, once the weight measuring device 130 determines that the amount of ice within the container 135B is less than five pounds, the processor 115 may send a computer readable signal to the ice maker 140 instructing it to transfer ice to the distributor 135 until the amount of ice within the container 135B is greater than twenty pounds. The ice produced by the ice maker 140 may be of many different shapes and sizes depending on the shape of ice mold of the ice maker. Shapes of ice distributed by the system 100 may include, but are not limited to, cube, half-cube, flake, nugget, crescent, and top hat, or any combination thereof. In some embodiments, the system 100 may distribute multiple shapes of ice depending on options chosen by the user 105 within the user interface 111.

The processor 115 is configured to perform the operations disclosed herein based on instructions stored within the system 100. The processor 115 may process instructions for execution within the computing device 110, including instructions stored in memory or on a storage device, to display graphical information for a graphical user interface (GUI) on an external input/output device, such as a display. The processor 115 may provide for coordination of the other components of a computing device 110, such as control of user interfaces 111, applications run by a computing device 110, and wireless communication by a communication device of the computing device 110. The processor 115 may be any processor or microprocessor suitable for executing instructions. In some embodiments, the processor 115 may have a memory device therein or coupled thereto suitable for payment data or other information disclosed herein. In some instances, the processor 115 may be a component of a larger computing device 110. A computing device 110 that may house the processor 115 therein may include, but is not limited to, laptops, desktops, workstations, personal digital assistants, servers, mainframes, cellular telephones, tablet computers, or any other similar device. Accordingly, the inventive subject matter disclosed herein, in full or in part, may be implemented or utilized in devices including, but are not limited to, laptops, desktops, workstations, personal digital assistants, servers, mainframes, cellular telephones, tablet computers, or any other similar device.

In an embodiment, the programming instructions responsible for the operations carried out by the processor 115 are stored on a non-transitory computer-readable medium (“CRM”) 116, which may be coupled to the processor 115. Alternatively, the programming instructions may be stored or included within the processor 115. Examples of non-transitory computer-readable mediums 116 include, but are not limited to, magnetic media such as hard disks, floppy disks, and magnetic tape; optical media such as CD ROM discs and DVDs; magneto-optical media such as optical discs; and hardware devices that are specifically configured to store and perform programming instructions, such as read-only memory (ROM), random access memory (RAM), flash memory, and the like. In some embodiments, the programming instructions may be stored as modules within the non-transitory computer-readable medium 116.

In the embodiment depicted in FIG. 1, the system 100 may further comprise a computing device 110 operably connected to the processor 115. The computing device 110 may be implemented in a number of different forms, including, but not limited to, servers, multipurpose computers, mobile computers, etc. For instance, a computing device 110 may be implemented in a multipurpose computer that acts as a personal computer for a user 105, such as a laptop computer. For instance, components from a computing device 110 may be combined in a way such that a mobile computing device is created, such as mobile phone. Additionally, a computing device 110 may be made up of a single computer or multiple computers working together over a network. For instance, a computing device 110 may be implemented as a single server or as a group of servers working together over and Local Area Network (LAN), such as a rack server system 100. Computing devices 110 may communicate via a wired or wireless connection. For instance, wireless communication may occur using a Bluetooth, Wi-Fi, or other such wireless communication device.

Some embodiments of the system 100 may further comprise a user interface 111. A user interface 111 may be defined as a space where interactions between a user 105 and the system 100 may take place. In an embodiment, the interactions may take place in a way such that a user 105 may control the operations of the system 100. A user interface 111 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, and graphical user interfaces, or any combination thereof. The system 100 may present data of the user interface 111 to the user 105 via a display operably connected to the processor 115. A display may be defined as an output device that communicates data that may include, but is not limited to, visual, auditory, cutaneous, kinesthetic, olfactory, and gustatory, or any combination thereof. FIG. 4 depicts certain preferred embodiment of the user interface 111 presented via a display. The upper pane depicts a preferred embodiment of a user interface 111 comprising a “start dispensing function” and “stop dispensing function” that may be selected by a user 105. To activate the system 100, the user 105 may select the “start dispensing” function within the user interface 111. To deactivate the system 100, the user 105 may select the “stop dispensing” function within the user interface 111. The lower pane depicts an embodiment of a user interface 111 comprising a plurality of functions that may instruct the system 100 which shape of ice a user 105 desires the system 100 to distribute. In a preferred embodiment, a user 105 may view the user interface 111 and select the functions of the user interface 111 via a touch screen.

Information presented via a display may be referred to as a soft copy of the information because the information exists electronically and is presented for a temporary period of time. Information stored on the non-transitory computer-readable medium 116 may be referred to as the hard copy of the information. For instance, a display may present a soft copy of visual information via a liquid crystal display (LCD), wherein the hardcopy of the visual information is stored on a local hard drive. For instance, a display may present a soft copy of audio information via a speaker, wherein the hard copy of the audio information is stored on a flash drive. For instance, a display may present a soft copy of tactile information via a haptic suit, wherein the hard copy of the tactile information is stored within a non-transitory computer-readable medium 116. Displays may include, but are not limited to, cathode ray tube monitors, LCD monitors, light emitting diode (LED) monitors, gas plasma monitors, screen readers, speech synthesizers, haptic suits, speakers, and scent generating devices, or any combination thereof.

The system 100 may further comprise a server. A server may be a search server, a document indexing server, and general web server. Servers may be separate entities performing different functions or similar functions. For instance, two or more servers may be implemented to work as a single server performing the same tasks. Alternatively, one server may perform the functions of multiple servers. For instance, a single server may perform the tasks of a web server and an indexing server. Although represented as a single server in FIG. 1, it is understood that multiple servers may be used to operably connect the processor 115 to the PoS. The processor 115 may be operably connected to the server via wired or wireless connection. Search servers may include one or more computing devices 111 designed to implement a search engine, such as a documents/records search engine, general webpage search engine, etc. Search servers, for example, may include one or more web servers configured to receive search queries and/or inputs from users 105, search one or more databases in response to the search queries and/or inputs, and provide documents or information, relevant to the search queries and/or inputs, to users 105. In some implementations, search servers may include a web search server that may provide webpages to users 105, where a provided webpage may include a reference to a web server at which the desired information and/or links is located. The references, to the web server at which the desired information is located, may be included in a frame and/or text box, or as a link to the desired information/document.

Document indexing servers may include one or more computing devices 110 designed to index documents available through networks. Document indexing servers may access other servers, such as web servers that host content, to index the content. In some implementations, document indexing servers may index documents/records stored by other servers connected to the network. Document indexing servers may, for example, store and index content, information, and documents relating to user 105 accounts and user-generated content. Web servers may include servers that provide webpages to clients. For instance, the webpages may be HTML-based webpages. A web server may host one or more websites. A website, as the term is used herein, may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

In a preferred embodiment, the computing device 110 may be operably connected to a PoS in a way such that a user 105 may use the PoS to use the system 100 and make purchases. As used herein, a PoS refers to the part of the system 100 where a user 105 may execute payment in order to use the system 100. The system 100 may be operably connected to the PoS via Bluetooth, Wi-Fi, fiber optic cable, or other such data transport technologies, but is not limited to these methods of communication. In one preferred embodiment, a user's 105 payment method must be verified before the user 105 may operate the system 100 to distribute ice. Once the payment method has been verified by the PoS, the system 100 may allow a user 105 to distribute ice using the methods as described herein. For instance, a PoS comprising a magnetic card reader may communicate information held on a magnetic card in a way such that a user 105 may purchase a quantity of ice from the system 100 using a credit card, wherein the computing device 110 may activate the system 100 upon verification of the credit card via the PoS. In a preferred embodiment, the user's 105 payment method will not be charged until the user 105 has finished using the system 100 to distribute ice. This is because the preferred embodiment of the system 100 will only charge a user 105 for the weight of ice distributed by the system 100. However, other embodiments of the system 100 may charge a user 105 a specified amount to operate the system 100 for a specified period of time. Upon insertion of the specified amount required to operate the system 100, the computing device 110 may send a computer readable signal to the motor 125 in a way such that the motor 125 is activated, which may allow the user 105 to operate the system 100 via the trigger mechanism. A timer of the computing device 110 may count down the specified period of time the user 105 has been granted to operate the system 100, sending a computer readable signal to deactivate the motor 125 once the allotted time period has expired. For instance, a user 105 may insert one dollar and fifty cents worth of quarters into a PoS comprising a coin slot, wherein the system 100 requires one dollar and fifty cents before a user 105 may operate the system 100 to distribute ice for up to one minute.

The system 100 may comprise a power supply. The power supply may be any source of power that provides the system 100 with electricity. In a preferred embodiment, the power supply comprises a stationary power outlet, such as a wall outlet. In one preferred embodiment, the system 100 may comprise of multiple power supplies that may provide power to the system 100 in different circumstances. For instance, the system 100 may be directly plugged into a stationary power outlet, which may provide power to the system 100 so long as it remains in one place. However, the system 100 may also be connected to a battery so that the system 100 may receive power and function even when the system 100 is not receiving power from a stationary power outlet. For instance, a system 100 located in an area experiencing a power outage may still receive power from a hydrogen fuel cell or other type of battery, allowing users 105 to obtain ice from the system 100 to preserve food that must be kept at lower temperatures to avoid spoilage.

In yet another embodiment, the power supply may comprise a plurality of solar panels. The plurality of solar panels may provide power directly to the system 100 or to a battery of the system 100, which may allow the system 100 to operate off the electrical grid for an extended period of time. For instance, a system 100 may be deployed in a field having no stationary power outlets at a music festival, allowing attendees of the music festival to have access to ice whenever in need. For instance, a disaster recovery center deployed in an area suffering from the devastating effects of a hurricane may use systems 100 powered by solar panels to provide ice to those in need of assistance. This will allow the disaster recovery center to provide additional assistance to victims of natural disasters without drawing power from the disaster recovery center's generators. Through these various embodiments of power supplies, the system 100 may always receive power so that it may distribute ice to users 105 in situations when users 105 may need it most.

System settings may be assigned to a requesting user 505, 525, 545 in a way such that the requesting user 505, 525, 545 may access certain system settings 515, 535, 555 via a user interface 111. In a preferred embodiment, a requesting user 505, 525, 545 is a user 105 that the system 100 has verified via the PoS. To access the system settings 515, 535, 555, a requesting user 505, 525, 545 may make a user request via the user interface 111 to the processor 115. In an embodiment, the processor 115 may grant or deny the request based on the permission level 500 associated with the requesting user 505, 525, 545. Only requesting users 505, 525, 545 having appropriate user roles 510, 530, 550 or administrator roles 565 may access the system settings 515, 535, 555 associated with a requesting user's 505, 525, 545 permission level 500. User roles 510, 530, 550 allow requesting users 505, 525, 545 to access the various system settings 515, 535, 555 of the system 100. For instance, as illustrated in FIG. 5, system settings 535 assigned to requesting user 2's user roles 530 may be different than those of requesting user 1 505 based on the amount paid by the requesting user 505, 525, 545, wherein paying a larger amount may grant a requesting user 505, 525, 545 access to a larger variety of shapes of ice distributed by the system 100 or grant the requesting user 505, 525, 545 a longer period of time to operate the system 100. For instance, requesting user 3 545 may have different system settings 555 assigned to her user role 550 based on a membership card recognized by the system 100 via the magnetic card reader of the PoS.

System settings 515, 535, 555 a requesting user 505, 525, 545 may choose from include, but are not limited to, the shape of ice the distributed by the system 100 and the amount of time the user 105 may operate the system 100. Shapes of ice that a requesting user 505, 525, 545 may choose to have the system 100 distribute include, but are not limited to, cube, half-cube, flake, nugget, crescent, and top hat. For instance, requesting user 3 545 may have the ability to choose top hat shaped ice based on her user role 550 but requesting user 1 505 and requesting user 2 525 may not have that ability based on their user roles 510, 530. Administrator roles 570 allow administrators 565 to access system wide data 580. Therefore, administrators 565 may access all system settings 515, 535, 555 a requesting user 505, 525, 545 may access as well as additional system settings a requesting user 505, 525, 545 may not access. In a preferred embodiment, additional system settings an administrator 565 may access via the user interface 111 include, but are not limited to, the speed at which ice is distributed by the system 100, the shapes of ice distributed by the system 100, the price of ice distributed by the system 100, and default ice shape distributed by the system 100, or any combination thereof.

FIG. 6 provides a flow chart 600 illustrating certain preferred method steps that may be used to carry out the method for distributing ice to a user 105. Step 605 indicates the beginning of the method. During step 610, the processor 115 may perform a query to determine if the PoS has confirmed the payment method of a user 105. The processor 115 may then determine how to proceed based on the results of the query during step 615. If the processor 115 determines that the PoS was unable to confirm a user's 105 payment method, the processor 115 may proceed to the terminate method step 665. If the processor 115 determines that the PoS was able to confirm a user's 105 payment method, the processor 115 may proceed to step 620. During step 620, the processor 115 may determine whether a system setting 515, 535, 555 has been chosen by a requesting user 505, 525, 545 via the user interface 111 that would indicate ice shape. The processor 115 may determine how to proceed based on the query during step 625. If the processor 115 determines no system setting 515, 535, 555 has been chosen to direct the system 100 as to which shape of ice should be distributed, the system 100 may default to whichever ice shape has been chosen by the administrator 565 as the default ice shape in step 627. The processor 115 may then proceed to step 630. In the preferred embodiment where only one shape of ice is distributed by the system 100, the method may proceed immediately from step 615 to step 630.

If the processor 115 determines that a system setting 515, 535, 555 has been chosen to direct the system 100 as to which shape of ice should be distributed, the processor 115 may proceed to step 630. During step 630, the processor 115 may receive weight data from the weight measuring device 130 to determine how much ice is currently within the distributor 135. The system 100 may then proceed to distribute ice in step 635. Once the ice has been distributed, the processor 115 may once again receive weight data from the weight measuring device 130 during step 640. Once the processor 115 has received all relevant weight data, the processor 115 may then perform an analysis during step 645 to determine the amount of ice distributed by the system 100 before proceeding to step 650. During step 650, the processor 115 may populate the user interface 111 with the final amount owed and the total amount of ice distributed by the system 100. The processor 115 may then display the final amount owed and total amount of ice via the display during step 655. Based on the weight of ice distributed by the system 100, the system 100 may charge the user 105 via the PoS during step 660. In embodiments in which a user 105 pays to use the system 100 via a coin slot, the processor 115 may skip this step. Once payment has been made, the processor 115 may proceed to the terminate method step 665.

FIG. 7 provides a flow chart 700 illustrating certain preferred method steps that may be used to carry out the method for operating the PoS to purchase ice from the system 100. Step 705 indicates the beginning of the method. During step 710, a user 105 may insert their payment into the PoS. In a preferred embodiment, the PoS may comprise a magnetic card reader and/or coin slot. Once payment has been accepted by the system 100, the user 105 may operate the user interface 111 in a way such that the user 105 may choose system settings during step 715. After the user 105 has selected the system settings within the user interface 111, the user 105 may obtain the ice container that the user 105 desires to fill with ice from the system 100 during step 720. The user 105 may then select the “start dispensing” function of the user interface 111 to activate the motor 125 of the system 100 during step 725. Once activated, the user 105 may remove the distribution tube 120A from its holster via the handle 120B and aim the nozzle end 120F of the distribution tube 120A in a way such that ice ejected from the nozzle end 120F will enter the chosen ice delivery location during step 730. The user 105 may then apply force to the trigger mechanism during step 735 such that the processor 115 sends a signal to the motor 125 that causes the drive rod 135C to rotate about a central axis, thus transferring ice from the system 100 to the user's 105 ice container. The user 105 may continue to apply force to the trigger mechanism until the desired amount of ice has been transferred to the ice container during step 740. Once the user 105 is satisfied with the amount of ice in the ice container, the user 105 may cease applying force to the trigger mechanism during step 745, which may cause the processor 115 to send a signal to the motor 125 that causes it to no longer rotate the drive rod 135C about a central axis. The user 105 may then select the “stop dispensing” function of the user interface 111 to deactivate the motor 125 during step 750. Once deactivated, the user 105 may replace the distribution tube 120A during step 755 before proceeding to the terminate method step 760.

The subject matter described herein may be embodied in systems, apparati, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one input/output device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, ices, and arrangements of the parts and method stages which have been described and illustrated in order to explain the nature of this inventive subject matter can be made without departing from the principles and scope of the inventive subject matter.

1) An ice delivery vending system, comprising:
an ice machine,
a distributor connected to a motor,
wherein said distributor is configured to convey ice from said ice machine to said nozzle,
a nozzle having a distribution tube,
wherein a distributor end of said distribution tube is secured to said distributor in a way such that ice is transferred from said distributor to said distribution tube,
wherein a nozzle end of said distribution tube is positionable to an ice delivery location,
a weight measuring device operably connected to said distributor,
wherein said weight measuring device determines changes in weight within said distributor,
a processor operably connected to at least one of said weight measuring device and said motor,
a power supply, and
a non-transitory computer-readable medium coupled to said processor and having instructions stored thereon, which, when executed by said processor, cause said processor to perform operations comprising:
receiving weight data from said weight measuring device,
calculating a weight change using said weight data.

2) The system of claim 1, further comprising a Point-of-Sale interface operably connected to said processor.

3) The system of claim 2, further comprising additional instructions stored on said non-transitory computer-readable medium, which, when executed by said processor, cause said processor to perform additional operations comprising:
calculating an amount owed using said weight change and a weight price, charging said amount owed using said Point-of-Sale interface.

4) The system of claim 1, wherein said distributor comprises:
a housing having a distribution hole,
a container shaped to securely fit within said housing,
wherein said container holds ice dispensed to said ice delivery location via said nozzle,
wherein an exit hole of said container and said distribution hole of said housing allow ice to escape said dispenser,
a drive rod connected to said motor, and
an agitator having a plurality of breaker bars,
wherein said agitator propels ice through said exit hole and said distribution hole to said nozzle.

5) The system of claim 1, wherein said nozzle further comprises a trigger mechanism that allows a user to control an output flow of ice from said distribution tube.

6) The system of claim 5, wherein said trigger mechanism further comprises a circuit,
wherein said circuit is operably connected to said motor,
wherein initiation of said circuit via said trigger mechanism causes actuation of said motor.

7) The system of claim 6, wherein said circuit is operably connected to said processor, wherein said circuit is activated and deactivated by said processor, wherein said circuit cannot send an ignition signal to said motor when said circuit is deactivated.

8) The system of claim 5, wherein said trigger mechanism further comprises a circuit,
wherein said circuit is operably connected to said processor,
wherein initiation of said circuit via said trigger mechanism sends a computer readable signal to said processor.
wherein said computer readable signal causes said processor to transmit an ignition signal to said motor,
wherein said ignition signal causes actuation of said motor.

9) The system of claim 8, further comprising additional instructions stored on said non-transitory computer-readable medium, which, when executed by said processor, cause said processor to perform additional operations comprising:
receiving said computer readable signal from said circuit,
determining whether said system is activated,
sending an ignition signal to said motor when it is determined said system is activated.

10) An ice delivery vending system, comprising:
an ice machine,
a distributor connected to a motor, said distributor comprising:
a housing having a distribution hole,
a container shaped to securely fit within said housing,
wherein said container holds ice dispensed to said ice delivery location via said nozzle,
wherein an exit hole of said container and said distribution hole of said housing allow ice to escape said dispenser,
a drive rod connected to said motor, and
an agitator having a plurality of breaker bars,
wherein said agitator propels ice through said exit hole and said distribution hole to said nozzle,
a nozzle having a distribution tube,
wherein a distributor end of said distribution tube is secured to said distributor at said distribution hole,
wherein a nozzle end of said distribution tube is positionable to an ice delivery location,
a weight measuring device operably connected to said distributor,
wherein said weight measuring device determines changes in weight within said distributor,
a processor operably connected to at least one of said weight measuring device and said motor,
a power supply, and
a Point-of-Sale interface operably connected to said processor.

11) The system of claim 10, wherein said nozzle further comprises a trigger mechanism that allows a user to control an output flow of ice from said distribution tube.

12) The system of claim 11, wherein said trigger mechanism further comprises a circuit,
wherein said circuit is operably connected to said motor,
wherein initiation of said circuit via said trigger mechanism causes actuation of said motor.

13) The system of claim 12, wherein said circuit is operably connected to said processor, wherein said circuit is activated and deactivated by said processor, wherein said circuit cannot send an ignition signal to said motor when said circuit is deactivated.

14) The system of claim 11, wherein said trigger mechanism further comprises a circuit,
wherein said circuit is operably connected to said processor,
wherein initiation of said circuit via said trigger mechanism sends a computer readable signal to said processor.
wherein said computer readable signal causes said processor to transmit an ignition signal to said motor,
wherein said ignition signal causes actuation of said motor.

15) The system of claim 14, further comprising additional instructions stored on said non-transitory computer-readable medium, which, when executed by said processor, cause said processor to perform additional operations comprising:
receiving said computer readable signal from said circuit,
determining whether said system is activated,
sending an ignition signal to said motor when it is determined said system is activated.

16) A method of delivering ice from an ice delivery vending system to an ice delivery location, said method comprising the steps of:
providing an ice vending deliver system, comprising:
an ice machine,
a distributor connected to a motor,
wherein said distributor is configured to convey ice from said ice machine to said nozzle,
a nozzle having a distribution tube,
wherein a distributor end of said distribution tube is secured to said distributor in a way such that ice is transferred from said distributor to said distribution tube,
wherein a nozzle end of said distribution tube is positionable to an ice delivery location,
a weight measuring device operably connected to said distributor,
wherein said weight measuring device determines changes in weight within said distributor,
a processor operably connected to at least one of said weight measuring device and said motor, and
a Point-of-Sale interface operably connected to the processor,
positioning said nozzle end of said nozzle towards the ice delivery location; and
activating said motor such that the distributor dispenses ice through the nozzle to the ice delivery location, and
calculating a weight change using weight data obtained from said weight measuring device.

17) The method of claim 16, further comprising the step of:
operating said point-of-sale interface in a way such that it activates the system.

18) The method of claim 17, further comprising the step of:
calculating an amount owed using said weight change.

19) The method of claim 16, further comprising the step of:
purchasing said ice distributed through said nozzle end of said nozzle via said Point-of-Sale interface.

20) The method of claim 16, further comprising the step of:
compressing a trigger mechanism of said nozzle in a way such that it causes actuation of said motor.
